(19) United States
(12) Patent Application Publication
(10) Pub. No.: US 2026/0111018 A1
(43) Pub. Date: Apr. 23, 2026

(54) Recognition and classification of objects for the monitoring of at least one machine

(71) Applicant: SICK AG, Waldkirch (DE)

(72) Inventor: Markus HAMMES, Waldkirch (DE)

(21) Appl. No.: 19/361,308

(22) Filed: Oct. 17, 2025

(30) Foreign Application Priority Data
Oct. 17, 2024 (EP) 24207162.9

(51) Int. Cl. G05B 23/02; G06T 7/00; G06V 10/147; G06V 10/764; G06V 10/82; G06V 20/52; G06V 40/10

(52) U.S. Cl. CPC G05B 23/0254; G06T 7/0004; G06V 10/147; G06V 10/764; G06V 10/82; G06V 20/52; G06V 40/10

(57) ABSTRACT

A device for the safe recognition and classification of objects for the monitoring of at least one machine is specified. The device has at least one image sensor for the acquisition of two-dimensional image data and three-dimensional image data and a control and evaluation unit that is configured for a machine learning method for the recognition and classification of the objects. The machine learning method has a first input channel for two-dimensional image data and a second input channel for three-dimensional image data and thus jointly recognizes and classifies the objects from the two-dimensional image data and the three-dimensional image data. In this respect, the machine learning method has a third input channel for further image features obtained from image data of the image sensor and the machine learning method thus jointly recognizes and classifies the objects from an additional image modality in addition to two-dimensional and three-dimensional image data.

The invention relates to a device and a method for the safe recognition and classification of objects for the monitoring of at least one machine, respectively.

Optoelectronic sensors are very frequently used in contactless monitoring for safeguarding hazards, for instance machines in an industrial environment or vehicles in logistics applications. A laser scanner and a camera, and in particular a 3D camera, can primarily be named here particularly for more complex applications. and thereby acquires depth information. The acquired three-dimensional image data having spacing values or distance values for the individual pixels are also called a 3D image, a distance image, or a depth map. There are 3D cameras in different technologies, including time of flight processes, stereoscopic processes, and projection processes or plenoptic cameras.

According to previous approaches in safety engineering, a protective field is usually monitored that may not be entered by operating personnel during the operation of the machine. If the sensor recognizes an unauthorized intrusion into the protective field, for instance a leg of an operator, the machine is transferred to a safe state. Sensors used in safety engineering have to work particularly reliably and must therefore satisfy high safety requirements, for example, the EN13849 standard for safety of machinery and the machinery standard EN61496 for electrosensitive protective equipment (ESPE). To satisfy these safety standards, a series of measures have to be taken such as a safe electronic evaluation by redundant, diverse electronics or different function monitoring processes, specifically the monitoring of the contamination of optical components, including a front lens.

For modern safeguarding concepts in the industrial manufacturing and logistics environment, on the other hand, there is the desire to base the safety consideration on more finely granulated information, in particular on the positions of objects and persons, as well as a classification that enables a distinction between a person and another object. This functionality is currently only offered by artificial intelligence (AI) methods, namely deep convolutional neural networks (CNN). Their efficiency is also based on the extensive, freely accessible image databases from which training data can be obtained.

Nevertheless, there is currently no approval for the use of such AI systems in safety engineering applications. Said use is not only opposed by formal hurdles, such as a lack of normative principles. Even very powerful neural networks at an individual image level do not yet achieve the residual error probabilities required in safety engineering due to a lack of sufficient accuracy and robustness. And even if the demands on the validation data are met, in the case of image interference due to extraneous light, motion blur, contamination or low contrast, it can occur that the accuracy is significantly reduced, and this is not tolerated in a safety engineering application.

Deep convolutional networks are known that have three input channels for the three color channels “R”, “G” and “B” of a color image. However, the features of ordinary color images are only reliable to a limited extent. The splitting into the color channels only leads to little gain in terms of the robustness expected for a safety application, because image interference, some of which are mentioned above, affect the different colors in a very similar way.

The paper by Weng, Xinshuo, et al, “Gnn3dmot: Graph neural network for 3d multi-object tracking with 2d-3d multi-feature learning”, Proceedings of the IEEE/CVF Conference on Computer Vision and Pattern Recognition, 2020, deals with neural networks for object tracking. Objects are recognized for an object tracking from frame to frame based on 2D and 3D image features. However, this is not intended for a safety engineering application and does not achieve the required accuracy and robustness.

It is therefore an object of the invention to find a recognition and classification possibility that is suitable for applications in safety engineering.

This object is satisfied by a device and a method for the safe recognition and classification of objects for the monitoring of at least one machine in accordance with the respective independent claim. The monitoring serves for the safety engineering application or the prevention of accidents or the protection of persons in the environment of the machine. Safe and safety mean, as in the entire description, that measures have been taken to control faults up to a specified safety level or to comply with specifications of a relevant safety standard for machine safety or electro-sensitive protective equipment, some of which are mentioned in the introduction. Unsafe is the opposite of safe and accordingly said demands on failsafeness are not satisfied for unsafe devices, transmission paths, evaluations, and the like.

At least one image sensor acquires two-dimensional image data and three-dimensional image data. They are typically images of an environment of the machine, but it can also be a somewhat more distant safety-relevant zone, for instance an access zone. In order to recognize and classify the objects, the image data are further processed in a control and evaluation unit using a machine learning method. The control and evaluation unit is any desired digital processing unit that is, for example, accommodated together with the image sensor in a housing of a camera or is connected to such a device. A machine learning method is characterized in that only a learning structure is predefined, while the specific evaluations are taught from training data. In contrast thereto, a classical method would specify a manually defined procedure, for instance in the form of an algorithm. Despite the incomplete conceptual agreement, a machine learning method can be understood as an artificial intelligence method.

The machine learning method has a first input channel for two-dimensional image data and a second input channel for three-dimensional image data. The method then makes its decision on the recognition and classification of the objects jointly based on the fed two-dimensional and three-dimensional image data. The numbering of the input channels has no meaning in terms of content; it is merely intended to differentiate the input channels conceptually.

The invention is based on the fundamental idea of a diverse three-channel input architecture. Therefore, an additional third input channel of the machine learning method is created. Further image data of an additional image modality, in addition to two-dimensional and three-dimensional image data, are derived from the image data of the image sensor and these further image data are fed to the third input channel. The machine learning method makes its decision on the recognition and classification of the objects based on the image data at the three input channels.

The invention has the advantage that a very good reliability and robustness is achieved by the three-channel input architecture with a high diversity or complementarity of the image features. Known interference influences, such as environmental light, lack of color contrast or remission contrast, object movement or loss of sharpness, only have a minor influence on at least one of the image channels and therefore do not impair the detection. The robustness of the classification can additionally be trained and tested by varying the weighting factors of the three input channels during the training and in statistical tests, for instance in the validation process. This leads to an improved reproducibility, in particular with respect to the robustness against certain interference influences.

The two-dimensional image data for the first input channel preferably have a gray scale image, in particular a gray scale image recorded under infrared illumination. The object recognition and classification of objects in a gray scale image can draw on established machine learning methods and extensive existing training data. The gray scale image can be recorded under natural lighting. A separate active illumination is preferably used, even more preferably in the infrared range. An additional differentiation in colors is conceivable in principle, wherein infrared can represent a separate color channel, but the invention is primarily based on input modalities that show fewer dependencies with respect to one another than colors.

The three-dimensional image data for the second input channel preferably have a depth map. In contrast to, for example, a 3D point cloud, a depth map has the advantage of a format corresponding to the two-dimensional image data. The architecture in the machine learning method can therefore incorporate the first and second input channel in a similar way. In this respect, the resolution of the depth map is preferably, but not necessarily, that of the two-dimensional image data. This can always be achieved by pre-processing (upsampling or downsampling). It is furthermore conceivable to convert the three-dimensional image data in a preparatory manner from any desired original format, for instance a 3D point cloud, into a depth map.

The control and evaluation unit is preferably configured to generate difference image data from two-dimensional image data recorded at different points in time and to feed said difference image data to the third input channel. The additional image modality introduced via the third input channel is thus a difference image that indicates changes and, above all, movement. The third input channel thus primarily contributes information content with respect to moving foreground objects that are particularly important for a safety monitoring. Furthermore, the differences or movements are very complementary to the static image features of the other two input channels, and they exhibit a very different behavior with respect to interference influences. Thus, a particularly high robustness and reliability of the overall system across the three diverse input channels is achieved.

The control and evaluation unit is configured to generate difference image data from three-dimensional image data recorded at different points in time and to feed said difference image data to the third input channel. The statements in the previous paragraph apply accordingly here. In addition, the difference image from three-dimensional image data is much more robust against changes in the light conditions and is thus more relevant for the objects of interest in many cases. However, changes and movements can be recognized independently of this determination, selectively in two-dimensional or three-dimensional image data depending on the embodiment. A fourth input channel would also be conceivable to assess changes from both two-dimensional image data and three-dimensional image data.

The recognition and classification preferably comprises a person recognition. For the safety engineering application, persons are usually the relevant objects. Accidents with another object must indeed also be avoided in the interests of productivity, but the purpose of safety engineering is to protect the health of people. The classification can be a binary classification of person/no person, or objects that are not classified as persons are not recognized as objects at all. A 3D system with a targeted person recognition is produced.

The recognition and classification preferably comprises a body part recognition. Therefore, not only is a person recognized as such, but a distinction is made according to the pose of said person or certain body parts such as hand, arm, leg, torso or head. The pose can be included in a safety assessment because certain poses, such as a person turning away from the machine, present significantly less risk or no risk at all. A differentiation according to body parts enables different safety levels; this allows analogous evaluations such as the resolution capacity of a classical safety sensor, for instance a light grid with a specific distance of the light beams that is matched to a body part.

The recognition and classification preferably comprises a determination of the position and/or movement of the objects. While in some applications it may be sufficient to know whether an object or a person is present in the field of view at all, a position enables a much more differentiated safety assessment. Thanks to the three-dimensional image data, this position can not only be a position within an image, but also a three-dimensional spatial position in the event of a correspondingly registered assembly of the image sensor. At this point, movement does not refer to the difference in the image modality of a third input channel, but rather to an evaluated movement of a recognized object in space. Position and movement can be determined at the level of persons, but also body parts.

The recognition and classification preferably comprises a safe object tracking. For this purpose, an object is recognized over time, i.e. across a plurality of recordings of the image sensor, and its respective position is determined. As already defined, safe means that the object tracking can be used as the basis for a safety assessment because the required robustness and reliability is achieved thanks to the three input channels. The object tracking, which initially concerns the past, can include a forecast for the future, for instance by means of Kalman filters or an extended or additional machine learning method. A safe object tracking is an important basic function for the most varied automation applications in production and logistics, for instance when a vehicle should evade a person and not simply stop. Equally, robots should use the knowledge of the exact position of a person in the vicinity to divert to other work zones and to maintain the productive processes. Future safeguarding solutions that have an influence on the automatic processes in a larger zone up to a whole workshop or factory on a superior plane likewise require knowledge of the positions of all the persons. All of this can already be partly achieved on the basis of current safe positions, but a safe object tracking offers even more possibilities.

The control and evaluation unit is preferably configured for a cross comparison that evaluates the agreement of the classification of the objects from the input channels. In other words, the results of the recognition and classification that initially individually result from the different input modalities at the input channels are therefore compared with one another. This can be based on a quality measure of the classification, for instance the measure that is evaluated in a softmax layer. For a cross comparison, the machine learning method must deliver appropriately itemized results, or these results are tapped early enough in the processing chain before in particular the machine learning method reaches a joint decision on all the input modalities in which a cross comparison would no longer be possible. The cross comparison can include all the input channels at the same time or a respective two input channels in pairs, in particular a plurality of or all conceivable pairs. Based on the assessment of the agreement—or lack of agreement—in the cross comparison, conclusions can be drawn as to whether an interference is possibly present and what type it could be. For example, a contamination can manifest itself in that the loss of contrast in the two-dimensional image data leads to a drop in the classification quality, while the latter is still high in the three-dimensional image data. Conversely, a mechanical shift would have hardly any effect on the detection in the two-dimensional image data, while three-dimensional image data would be severely impaired after a consideration of a taught-in background. Signatures for certain error images can be generated according to such rules. Some error images can still be tolerated, others no longer, and a further diagnostic tool is available in any case.

The machine learning method preferably has a neural network, in particular a deep convolutional neural network (CNN). A large number of existing and proven architectures can be used here, at least as a module or a basis.

The neural network preferably has a three-channel architecture comprising three network input channels, wherein the first input channel, the second input channel and the third input channel are guided to the three network input channels. The three input channels can thus be found in the architecture of the neural network in this embodiment. Alternatively, a pre-processing would, for example, be conceivable that guides the input channels to more or fewer network input channels, or, for example, the use of a plurality of neural networks for individual or different combinations of the input channels. The neural network outputs recognized objects, object classes and/or features that allow recognized objects and object classes to be concluded. The output can include additional information such as a position, movement, subdivision into body parts and the like. Optionally, it is conceivable to also output the recognition per image modality, or confidence values therefor, in order to facilitate a diagnosis and a reliability assessment.

Preferably, the neural network uses a three-channel architecture of a neural network for the processing of the three color channels of a two-dimensional color image. In other words, this embodiment is based on an architecture known per se. However, the three color channels for red, green and blue that are present there are reallocated, now for the two-dimensional image data, the three-dimensional image data and the further image modality, in particular difference image data. The original three color channels are only independent of one another to a limited extent; they do not represent complementary features in terms of safety engineering. With the reallocated color channels, the three-channel, diverse input architecture is produced that thus opens up known architectures and in particular deep convolutional networks for safety engineering.

The neural network is preferably pre-trained with color images in that a respective one of the three color channels of the respective color image is guided to a respective one of the three network input channels during a pre-training. In a pre-training, the neural network is therefore still used according to its original RGB color architecture. Very large training data sets that are still unspecific for the subsequent safety application are available for this purpose. A basic recognition of objects and target classes, in particular persons, is thus already possible. In a further training, continued training, subsequent training or fine-tuning, training data are then used according to the actually provided image modalities, i.e. two-dimensional image data, three-dimensional image data and image data of the further image modality, in particular difference image data. Thanks to the pre-training, the scope of the more specific training data can remain much smaller.

The image sensor preferably acquires three-dimensional image data according to the time-of-flight principle. In other words, a special 3D camera, a time-of-flight (TOF) camera, is used. In addition to times of flight, this 3D camera can also measure intensities and can thus likewise provide the two-dimensional image data. Alternatively, other 3D methods are conceivable, for example stereoscopy, and/or a distribution of the 3D acquisition and 2D acquisition over a plurality of image sensors or cameras. Furthermore, a 3D acquisition by means of a laser scanner is also conceivable, wherein a laser scanner can likewise measure intensities or be equipped with an additional 2D image sensor.

The control and evaluation unit is preferably configured to trigger a safeguarding of the machine if a recognized object is at a hazardous position and/or in a hazardous motion. Thus a downstream assessment of the control and evaluation unit as to whether a recognized object, an object class or additional information, such as position or motion, leads to a hazard that must be responded to. A hazardous position may be too close to a machine or a machine part, with possible time dependencies or the consideration of work sequences of the machine. Movements enable additional assessments because, for example, a movement parallel to the machine or even with a partial component away from it is less critical than a movement directly towards the machine. The speed can also play a role (speed-and-separation monitoring). The safeguarding can consist of evading, slowing down or stopping the machine or assuming another safe state.

The method is a computer-implemented method that runs, for example, on a processing unit of an optoelectronic sensor for acquiring the two-dimensional and/or three-dimensional image data and/or a connected processing unit. The method according to the invention can be further developed in a similar manner to the device and exhibits similar advantages in this respect. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The images of the drawing show in:

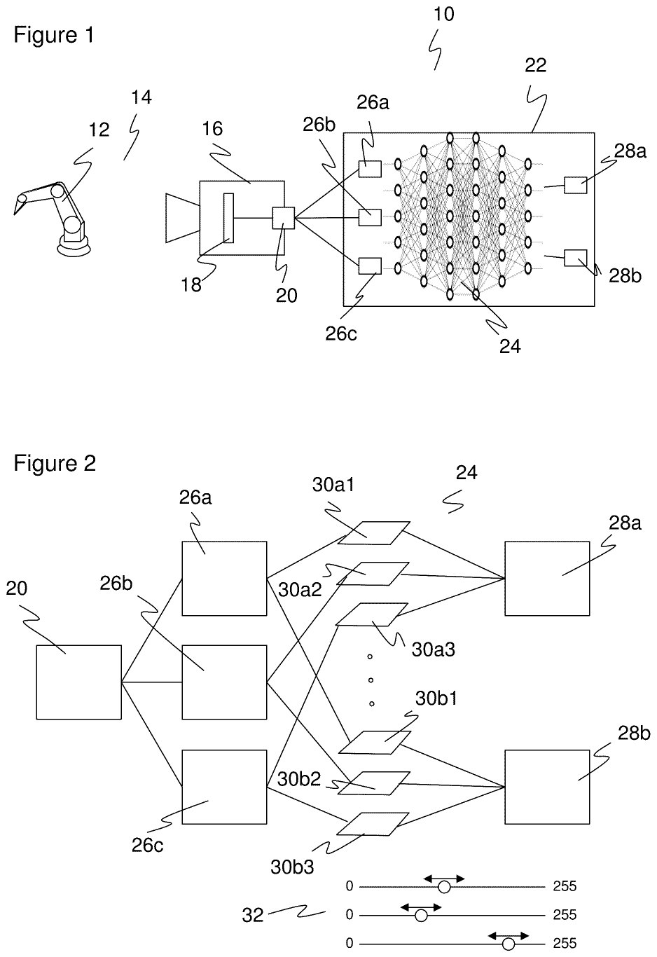

FIG. 1 a schematic overview representation of a device for monitoring a machine;

FIG. 2 a schematic representation of a three-channel architecture of a neural network for the recognition and classification of objects in the environment of a machine;

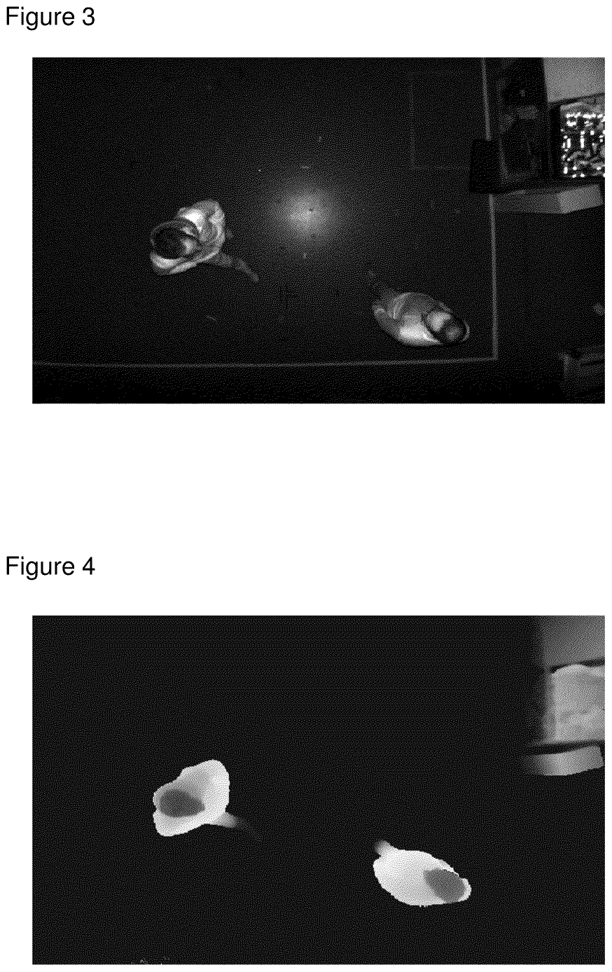

FIG. 3 an example of two-dimensional image data that are fed to one of the three input channels of the neural network in accordance with FIG. 2;

FIG. 4 an example of three-dimensional image data that are fed to one of the three input channels of the neural network in accordance with FIG. 2;

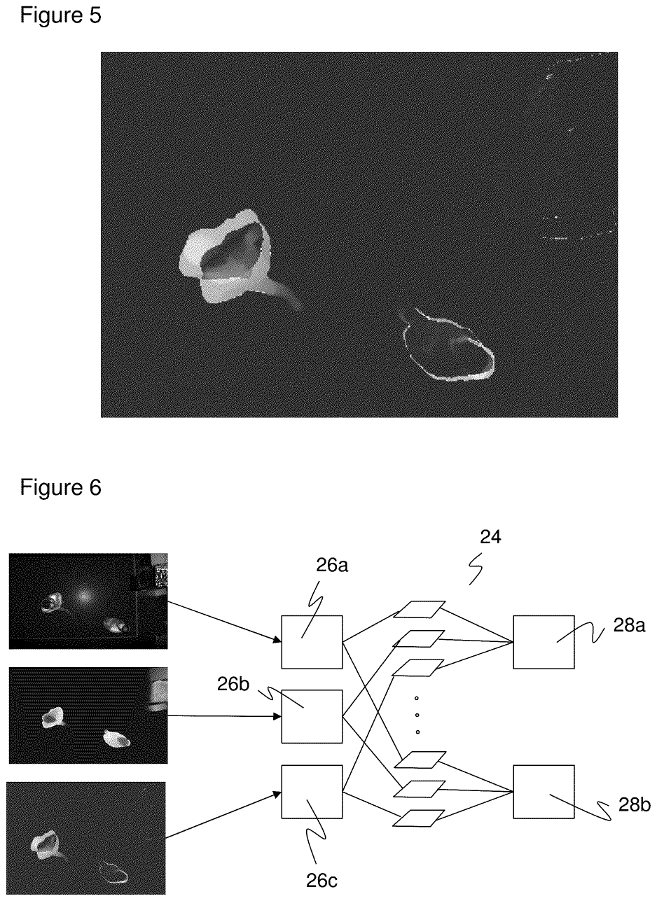

FIG. 5 an example of difference image data that are fed to one of the three input channels of the neural network in accordance with FIG. 2; and

FIG. 6 a schematic representation of the assignment of the different image modalities to the input channels of the neural network in accordance with FIG. 2.

FIG. 1 shows a schematic overview representation of a device 10 for monitoring a machine 12. The machine 12 is located in a monitored zone 14 of an optoelectronic sensor 16 that is shown here by way of example as a camera comprising an image sensor 18 that in particular has a plurality of light reception elements or pixels, which are arranged to form a matrix, and an interface 20. The optoelectronic sensor 16 is capable of acquiring two-dimensional and three-dimensional image data. A suitable technical design for this purpose is a time-of-flight camera; other 3D cameras such as a stereo camera or a laser scanner would also be conceivable. It is also possible to use a plurality of optoelectronic sensors 16, be it as in the case of a stereo camera to support the 3D acquisition or to obtain additional perspectives for a larger monitored zone, different views or to avoid shadows. The optoelectronic sensor 16 can be assigned an internal or external illumination, not shown, in particular for generating infrared light.

The image data of the image sensor 18 are transferred via the interface 20 to a control and evaluation circuit 22. As shown, the control and evaluation unit 22 can be an external processing unit, alternatively an internal processing unit of the optoelectronic sensor 16, or a combination of both. Examples of an internal processing unit are digital processing modules such as a microprocessor or a CPU (Central Processing Unit), an FPGA (Field Programmable Gate Array), a DSP (Digital Signal Processor), an ASIC (Application-Specific Integrated Circuit), an AI processor, an NPU (Neural Processing Unit), a GPU (Graphics Processing Unit), a VPU (Video Processing Unit) or the like. An external processing unit can likewise have one of these digital processing modules and can in particular be a computer of any desired design, including notebooks, smartphones, tablets, a (safety) controller, equally a local network, an edge device or a cloud.

A machine learning method is implemented in the control and evaluation unit 22, in particular a (deep) neural network or convolutional network, that is referred to below in simplified terms as a neural network 24, without thereby excluding other machine learning methods. The image data of the image sensor 18 are fed to three input channels 26a-c of the neural network 24 in three different image modalities, namely two-dimensional image data, three-dimensional image data and a further image modality derived therefrom, in particular a difference of two-dimensional image data or a difference of three-dimensional image data. At the output side, the neural network 24 provides information about recognized objects and an associated classification, wherein this is initially generally shown as features 28a-b. This will be explained even more precisely below.

This output information is further processed without its own representation in order to arrive at a safety assessment, i.e. whether the recognized objects, the classes of recognized objects and/or additional information such as their position and movement behavior signify a hazardous situation. In the event of imminent danger, a safe output signal is generated in order to initiate a safety-related reaction of the machine 12, such as a slowing down, an evading, an alternative movement sequence or a braking, if necessary, up to stopping.

FIG. 2 shows a schematic representation of an embodiment of the invention with a three-channel architecture of the neural network 24 for the recognition and classification of objects in the environment of a machine. The invention can be based on a separate architecture comprising three input channels 26a-c. Preferably, however, a three-channel deep convolutional neural network is used to analyze color images or RGB images with three color channels. The neural network 24 has different layers or planes 30a1-30b3 arranged downstream of the input channels 26a-c. The structure can be even more complex than shown and can have further typical elements of a neural network 24, such as convolutional layers, pooling layers, fully connected layers or an attention mechanism that has become known from the transformers. Such architectures are known in many cases for the processing of color images, and are therefore not described in detail.

Originally, the three input channels 26a-c are each supplied with a red, green and blue partial image of a color image. According to the invention, three different image types or modalities are now supplied instead of the RGB components of a color image: two-dimensional image data or a gray scale image or intensity image, three-dimensional image data or a depth map and a difference image. The difference image is created by a difference formation of images recorded at two different points in time, preferably from the difference of three-dimensional image data or depth maps, alternatively from the difference of two-dimensional image data or gray scale images or intensity images.

As output-side features 28a-b, either already recognized objects and classes of objects or features 28a-b are output, from which this can be derived simply and without further recourse to machine learning methods. The schematic sliders 32 at the bottom in FIG. 2 are still based on a color mixture. They are intended to illustrate that a joint decision is made on all input-side image modalities, but that they can still be weighted differently.

It is possible to train the neural network 24 from scratch with training data in the image modalities provided according to the invention. Such training data are referred to below as application-specific, and such training data can indeed be obtained, but nowhere near to the extent that freely available general image data can be found. For this reason, the neural network 24 is preferably initially pre-trained with color images in the three color channels. Only then does a further training, a subsequent training or a fine-tuning take place with the comparatively valuable application-specific training data. In this way, the pre-trained neural network 24, which is initially configured for color image processing, is adapted for the image modalities according to the invention. In contrast to color channels, the image modalities according to the invention are characterized to a particular degree by complementary or independent information and features, thus achieving a high reliability and robustness.

In order to take a somewhat more precise look at the image modalities according to the invention, FIG. 3 first shows an example of two-dimensional image data that are fed to the first input channel 26a of the neural network in accordance with FIG. 2 without any restriction of generality. Information about the two-dimensional shapes, about brightnesses and contrasts can be found in this image. Specifically, an intensity image in the near infrared range was recorded in this example image. Other variants of a gray scale image or intensity image under natural lighting or artificial lighting in a different spectrum are likewise possible. The first input channel 26a is most similar to a conventional RGB channel so that a network pre-trained from color images should be able to cope well with this image modality, i.e. already provides a fairly reliable object recognition and classification. It is conceivable to already pre-process the two-dimensional image data upstream of the neural network 24, for example, to perform a masking of a background that can in particular be recognized very easily from the three-dimensional image data using a distance criterion. A possible source of false detections is thereby omitted; the evaluation is focused more strongly on the relevant objects in the foreground.

FIG. 4 shows an example of three-dimensional image data that are fed to the second input channel 26b of the neural network 24 in accordance with FIG. 2. Such a depth map or a depth image contains distances, thus 3D contour information of the objects, in general 3D shapes and sizes, an orientation and a reference with respect to a ground plane. The format is very similar to a color image and an intensity image since here, too, each pixel is assigned a numerical value, only in the three-dimensional case a distance value instead of an intensity value or gray scale value as in the two-dimensional case, now instead of an intensity. Any difference in resolution can be compensated for by pre-processing. However, the information is very complementary in terms of content. In addition, three-dimensional image data already provide an inherently high robustness with respect to contrast fluctuations or environmental light influences. In the three-dimensional image data, a background can also be masked in advance, for example, if it was initially taught in.

FIG. 5 shows an example of difference image data that are fed to the third input channel 26c of the neural network 24 in accordance with FIG. 2. The difference between two images recorded at different times has been formed for this purpose. The images can be recorded directly or with a larger offset after one another in an image sequence. The difference image shown is obtained from three-dimensional image data, i.e. two depth maps recorded at different points in time in accordance with FIG. 4. Alternatively, a difference image can be generated from two-dimensional image data, i.e. two intensity values or gray scale images recorded at different points in time in accordance with FIG. 3.

In a difference image, the changes generally remain that are, in turn, primarily caused by movements. Said difference image contains information about changed positions, directions of movement, speeds and changes in shape. In the three-dimensional case, in particular moving object edges and object surfaces, which are inclined in relation to the ground plane, are particularly emphasized. The evaluation of the difference image is very sensitive to moving objects and insensitive to motion blur. Due to the difference formation, changes in the background are furthermore suppressed. The feature “movement” is a very strong feature for safety engineering applications and is very reliable in particular in connection with persons.

FIG. 6 shows a schematic representation of the assignment of the different image modalities to the input channels 26a-c of the neural network 24 in accordance with FIG. 2. At the left-hand side, the three input images presented in FIGS. 3 to 5 are shown again and are assigned to their input channels 26a-c. Due to the different input-side image modalities, highly reliable and unambiguous features for the recognition and classification of the objects are available to the neural network 24 with pure image features, 3D geometry features and motion features. In principle, each channel is per se already capable of recognizing persons. Due to the diverse-redundant approach according to the invention, this recognition becomes much more robust and reliable. If an interference influence, such as the loss of contrast due to contamination, affects one channel, the recognition and classification with the remaining information of the other channels still remains reliable. Furthermore, a cross comparison between the channels is conceivable that checks the agreement of the classification and draws conclusions therefrom as to which error image is possibly present. Such conclusions can be formally summarized in the form of signatures, typical deviations between the channels.

The procedure described with a pre-training in ordinary color channels and a subsequent training on the special image modalities according to the invention is possible because basic features of persons that have been learned from a color image can be found anyway in an intensity image, but also in the shapes and movement patterns of the other two image modalities, at least in the main features. Alternatively, a neural network 24 can be trained without pre-training solely on the basis of suitable training data sets in the image modalities according to the invention. Thus, the advantage that the essential features of persons can already be learned from large, easily available training data sets, is lost, however; in other words, the training effort increases because much more application-specific training data have to be obtained.

The invention also facilitates the verification of the robustness, which verification is important in safety engineering applications. As indicated by the sliders 32 in FIG. 2, channels can be intentionally amplified and attenuated in order to examine the performance of the neural network 24 under the respective changed conditions. This procedure can be defined as part of the release tests.

In addition to this robustness test before the actual use, the plurality of channels can also be used at the runtime as a detection mechanism for interference influences. An omission or a partial loss of image features, for example the image sharpness in the case of contamination, will manifest itself in very recognizably different, the activation pattern, or other runtime indicators, or interference signatures tailored thereto.

The three-channel architecture shown is preferred in terms of handling and performance. Nevertheless, it would alternatively be conceivable to use three parallel part networks for one image modality each and then to subsequently merge the partial results with classical methods or a further neural network. The idea of triple diversity can also be extended to other image modalities, wherein the requirement must be satisfied that good, independent features are included.

1. A device for the safe recognition and classification of objects for the monitoring of at least one machine, wherein the device has at least one image sensor for the acquisition of two-dimensional image data and three-dimensional image data and a control and evaluation unit that is configured for a machine learning method for the recognition and classification of the objects, which machine learning method has a first input channel for two-dimensional image data and a second input channel for three-dimensional image data and thus jointly recognizes and classifies the objects from the two-dimensional image data and the three-dimensional image data,
wherein the machine learning method has a third input channel for further image features obtained from image data of the image sensor and thus jointly recognizes and classifies the objects from an additional image modality in addition to two-dimensional and three-dimensional image data.

2. The device according to claim 1,
wherein the two-dimensional image data for the first input channel comprise a gray scale image.

3. The device according to claim 2,
wherein the gray scale image is a gray scale image recorded under infrared illumination.

4. The device according to claim 1,
wherein the three-dimensional image data for the second input channel comprise a depth map.

5. The device according to claim 1,
wherein the control and evaluation unit is configured to generate difference image data from two-dimensional image data recorded at different points in time and to feed said difference image data to the third input channel.

6. The device according to claim 1,
wherein the control and evaluation unit is configured to generate difference image data from three-dimensional image data recorded at different points in time and to feed said difference image data to the third input channel.

7. The device according to claim 1,
wherein the recognition and classification comprises a person recognition and/or a body part recognition.

8. The device according to claim 1,
wherein the recognition and classification comprises a determination of the position and/or movement of the objects and/or a safe object tracking.

9. The device according to claim 1,
wherein the control and evaluation unit is configured for a cross comparison that evaluates the agreement of the classification of the objects from the input channels.

10. The device according to claim 1,
wherein the machine learning method comprises a neural network.

11. The device according to claim 10,
wherein the neural network is a deep convolutional network.

12. The device according to claim 10,
wherein the neural network has a three-channel architecture comprising three network input channels, wherein the first input channel, the second input channel and the third input channel are guided to the three network input channels.

13. The device according to claim 12,
wherein the neural network uses a three-channel architecture of a neural network for the processing of the three color channels of a two-dimensional color image.

14. The device according to claim 13,
wherein the neural network is pre-trained with color images in that a respective one of the three color channels of the respective color image is guided to a respective one of the three network input channels during a pre-training.

15. The device according to claim 1,
wherein the image sensor acquires three-dimensional image data according to the time-of-flight principle.

16. The device according to claim 1,
wherein the control and evaluation unit is configured to trigger a safeguarding of the machine if a recognized object is at a hazardous position and/or in a hazardous motion.

17. A method for the safe recognition and classification of objects for the monitoring of at least one machine, wherein two-dimensional image data and three-dimensional image data are recorded and are evaluated using a machine learning method for the recognition and classification of the objects, which machine learning method has a first input channel for two-dimensional image data and a second input channel for three-dimensional image data and thus jointly recognizes and classifies the objects from the two-dimensional image data and the three-dimensional image data,
wherein the machine learning method has a third input channel for further image features obtained from image data of the image sensor and thus jointly recognizes and classifies the objects from an additional image modality in addition to two-dimensional and three-dimensional image data.
